(19) United States
(12) Patent Application Publication
(10) Pub. No.: US 2014/0105251 A1
(43) Pub. Date: Apr. 17, 2014

(54) LEAKAGE DETECTION IN AN ALL-DIGITAL CABLE DISTRIBUTION NETWORK

(71) Applicant: Effigis Geo Solutions, Montreal (CA)

(72) Inventor: Magella Bouchard, Outremont (CA)

(73) Assignee: Effigis Geo Solutions, Montreal (CA)

(21) Appl. No.: 14/055,515

(22) Filed: Oct. 16, 2013

Related U.S. Application Data
(60) Provisional application No. 61/714,677, filed on Oct. 16, 2012.

(51) Int. Cl. H04B 1/707

(52) U.S. Cl. CPC H04B 1/707
USPC 375/141

(57) ABSTRACT

The present document describes a method for detecting a leak in an all-digital cable distribution network comprising a head station for transmitting content to subscribers using channels that are encoded using quadrature amplitude modulation (QAM), the method comprising: injecting at the head station, through the cable distribution network and using a direct sequence spread spectrum (DSSS) transmitter, a DSSS signal of a frequency range not overlapping with an adjacent QAM channel; travelling the area where the cable distribution network is deployed, with a DSSS receiver tuned to the DSSS transmitter at the head station; and upon detecting, at the DSSS receiver, a DSSS signal leaking through the leak of the cable distribution network, determining the location of leak for repair, or generating a leakage event data package that may be transmitted or stored.

### CROSS-REFERENCE TO RELATED APPLICATIONS

This application claims priority of U.S. provisional patent application 61/714,677, filed on Oct. 16, 2012, the specification of which is hereby incorporated by reference.

### BACKGROUND

(a) Field

The subject matter disclosed generally relates to the detection of leakage in all-digital cable distribution networks.

(b) Related Prior Art

Previous techniques of inserting a signal with a signature for detecting egress signals in “Analog” Cable can no longer be used with Digital Cable Networks.

The conventional technique for detecting leakage is to detect and measure the video carrier of a channel located within the aeronautical band (108-135 MHz). However, in all-digital networks, these carriers are not available for the detection of radiation.

In order to protect communications services and aeronautical navigation systems, the radiation detection on analog networks traditionally occurs at a frequency which is close to or within the aeronautical bands. The vast majority of operators use a video carrier (channel 14, 15 or 16) or a continuous wave (CW) carrier near the FM band. Measurement techniques have been developed to detect and measure the maximum power level that can radiate from a leaking signal in the network and potentially compromise the safe use of aeronautical bands.

The Cumulative Leakage Index (aka CLI index) used to assess the level of radiation from cable networks was specifically developed in the context of the use of analogue carriers within aeronautical bands. Although the need to protect the aeronautical bands remains the same, technological environment has changed significantly since the establishment of standards and methods of radiation measurement.

Government Regulations such as promulgated by the United States Federal Communications Commission (FCC) and Industry Canada (IC) still require cable operators to provide, at regular intervals, radiation measurements including the calculation of the CLI index. However, the prescribed measuring has not been adapted to a fully digital context. Therefore, cable operators must continue to measure the impact of their networks using either a video carrier located near the aeronautical bands, or a dedicated Continuous Wave (CW) carrier. To use another method of measuring, it is first necessary to demonstrate that the detection meets the same criteria used to establish the standard CLI index to protect communication systems and aircraft navigation. Telecommunication companies are also increasingly concerned with the interference of leakage with the Long Term Evolution (LTE) band. As more and more specific frequencies are used widely, the need for leakage detection in all-digital cable communications grows accordingly.

Therefore, previous techniques of inserting a signal with a signature for detecting egress signals in “Analog” Cable Networks are now impossible with Digital Cable Networks because the carriers previously used for the detection of radiation are no longer available in all-digital networks.

Furthermore, preventive maintenance of Hybrid Fiber Coaxial (HFC) networks has become much more important since the advent of digital services and bidirectional networks. For operators, the main concern is the quality of the customer experience. The main feature of digital systems is that quality is rapidly degraded to the point of making the service non-functional when interference exceeds the threshold. It therefore becomes imperative to control potential sources of interference and especially to be able to quickly identify them when receiving service calls.

Some methods and apparatuses exist to detect leakages of digital signals, such as the product described in WO 2011022197 A1, by Victor M. Zinevich, published on Feb. 24, 2011. However, the existing methods and apparatuses detect Quadrature Amplitude Modulation (QAM) channels. This way of doing things has many defects that can be corrected by using Direct Sequence Spread Spectrum (DSSS) signals as described herein.

Therefore, there is a need in the market for a method/system for detecting leakage in all-digital cable distribution networks.

### SUMMARY

The present embodiments provide such method and system.

In an embodiment, there is provided a method for detecting a leak in an all-digital cable distribution network deployed in an area and comprising a head station for transmitting content to subscribers using channels that are encoded using quadrature amplitude modulation (QAM), the method comprising: injecting at the head station, through the all-digital cable distribution network and using a direct sequence spread spectrum (DSSS) transmitter, a DSSS signal of a frequency range not overlapping with an adjacent QAM channel; travelling the area where the all-digital cable distribution network is deployed, with a DSSS receiver tuned to the DSSS transmitter at the head station; upon detecting, at the DSSS receiver, a DSSS signal leaking through the leak of the cable distribution network, collecting data indicative of a strength of the DSSS signal and associating the collected data with a location at which the DSSS signal was detected for generating leakage event data; and at least one of transmitting and storing the leakage event data for processing.

According to another embodiment, detecting the DSSS signal at the DSSS receiver comprises de-spreading the signal for retrieving an original modulated signal.

According to another embodiment, generating a leakage event data comprises processing the leakage event data to eliminate multiple appearances of a leak.

According to another embodiment, generating a leakage event data further comprises generating a map indicating the leak.

According to another embodiment, generating a map indicating leak events comprises using specific symbols to indicate at least one of a type of event and a signal strength, the specific symbols comprising at least one of a specific shape and a specific color.

According to another embodiment, the method further comprises dispatching repairs to a work force management system via a data interface.

In another aspect of the invention, there is provided a method for detecting a leak in an all-digital cable distribution network deployed in an area and comprising a head station for transmitting content to subscribers using channels that are encoded using quadrature amplitude modulation (QAM), the method comprising: injecting at the head station, through the all-digital cable distribution network and using a direct sequence spread spectrum (DSSS) transmitter, a DSSS signal of a frequency range not overlapping with an adjacent QAM channel; travelling the area where the all-digital cable distribution network is deployed, with a DSSS receiver tuned to the DSSS transmitter at the head station; upon detecting, at the DSSS receiver, a DSSS signal leaking through the leak of the all-digital cable distribution network, determining a location of a leak for repair.

According to another embodiment, detecting the DSSS signal comprises collecting data indicative of a strength of the DSSS signal for determining the location of a leak.

According to another embodiment, detecting the DSSS signal at the DSSS receiver comprises de-spreading the signal for retrieving an original modulated signal.

In another aspect of the invention, there is provided a system for detecting a leak in an all-digital cable distribution network deployed in an area, the system comprising: a head station for transmitting content to subscribers using channels that are encoded using quadrature amplitude modulation (QAM); a direct sequence spread spectrum (DSSS) transmitter for injecting at the head station, through the all-digital cable distribution network, a DSSS signal of a frequency range not overlapping with an adjacent QAM channel; and a DSSS receiver tuned to the DSSS transmitter at the head station for detecting a DSSS signal leaking through the leak of the all-digital cable distribution network.

According to another embodiment, the system further comprises a processor configured for determining a location of a leak for repair.

According to another embodiment, the DSSS receiver is installed on a vehicle for travelling the area where the all-digital cable distribution network is deployed.

According to another embodiment, the vehicle comprises a geo-locating device installed thereon for determining the location at which the DSSS signal was detected.

According to another embodiment, the DSSS receiver comprises a handheld portable receiver.

According to another embodiment, the DSSS transmitter for injecting the DSSS signal comprises a DSSS transmitter for injecting the DSSS signal of a bandwidth comprised between 400 kHz and 600 kHz.

According to another embodiment, the DSSS receiver comprises a FPGA configured for frequency tuning the DSSS receiver to the DSSS transmitter.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic diagram which illustrates the main component of a system used for detecting leakage in an all-digital cable distribution network, in accordance with an embodiment;

FIG. 2 is a graph which illustrates the sidelobes that exist on a QAM channel;

FIG. 3 is a graph illustrating a MATLAB simulation along with the measured QAM channel roll off;

FIG. 4 is a high-level block diagram which shows a DSSS transmitter, in accordance with an embodiment;

FIG. 5 is a high-level block diagram which shows a DSSS receiver, in accordance with an embodiment;

FIG. 6 is a graph which illustrates an exemplary visualization of the jammer, in accordance with an embodiment;

FIG. 7 is a graph which illustrates the notch between two adjacent QAM channels;

FIG. 8 is a graph which illustrates an example of a high-level block diagram of an optimized DSSS receiver, in accordance with an embodiment;

FIG. 9 is a graph illustrating the performance of each type of modulation;

FIG. 10 is a block diagram illustrating a high level architecture of another DSSS transmitter, in accordance with another embodiment;

FIG. 11 is a block diagram illustrating a high level architecture of a DSSS receiver that is compatible with the transmitter of FIG. 10, in accordance with another embodiment;

FIG. 12 is a block diagram of a DSSS receiver in accordance with another embodiment.

FIG. 13 is a block diagram illustrating a part of a DSSS receiver used for real-time correlation, according to an embodiment;

FIG. 14 is a screen show of an exemplary illustration of an Event Map showing ingress/leak events identified by color and form legend within a geographical area; and

FIG. 15 is a flowchart of a method for detecting a leak in a cable distribution network and determining its location, according to an embodiment.

It will be noted that throughout the appended drawings, like features are identified by like reference numerals.

### DETAILED DESCRIPTION

A problem that this invention resolves is related to the detection of leaks in so-called “Digital” Cable Networks where channels are encoded using QAM (Quadrature amplitude modulation). QAM is the format by which digital cable channels are encoded and transmitted via cable television networks.

In an embodiment, there is provided a method for detecting leakage in an all-digital cable distribution network wherein a transmitter at the head of the network injects a Direct Sequence Spread Spectrum (DSSS) signal between two adjacent QAM channels. Alternatively, for a side QAM channel, the DSSS signal is not injected between two adjacent QAM channels, but rather beside an adjacent QAM channel. According to an embodiment, the DSSS signal should not be superimposed on a QAM channel (i.e., in a frequency range not overlapping with an adjacent QAM channel).

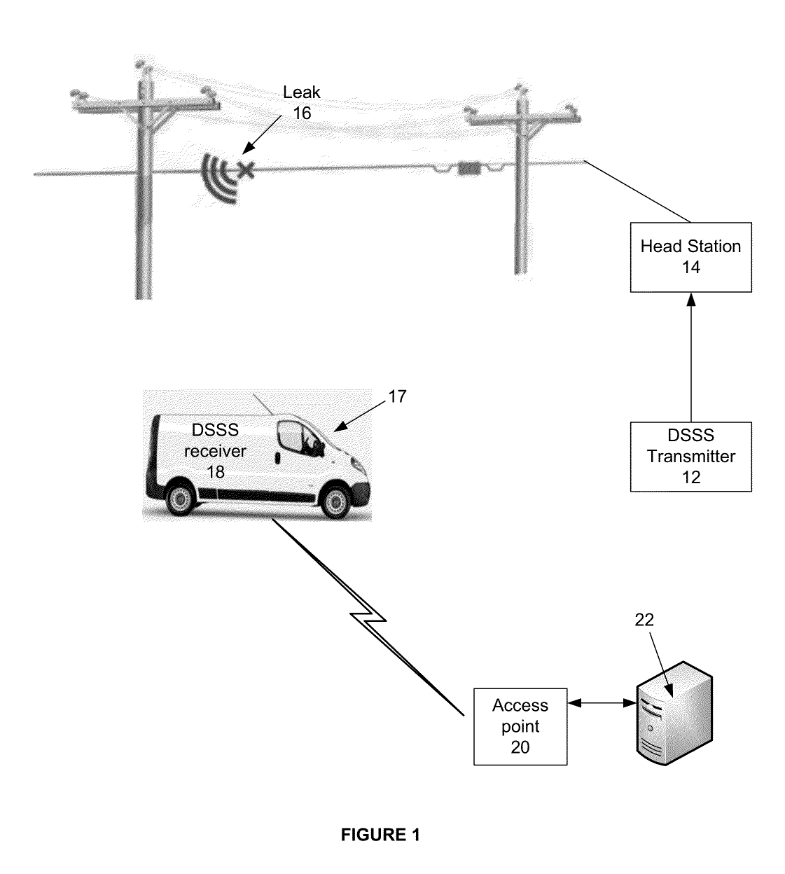

The DSSS signal is strong enough to be detected by the receiver without affecting the content in the channels. According to an embodiment, a receiver, installed in a vehicle which travels the city where the all digital cable network is installed, detects the DSSS signal in areas where leaks occur and automatically records the location of the leaks in the network through GPS or other means. An example is provided in FIG. 1. Although having an autonomous receiver is practical, it may be manually activated for detection for specific reasons. It is also possible to imagine a receiver that is not being moved by a vehicle or an individual during the detection (either because it is motionless, or moved by another mechanism).

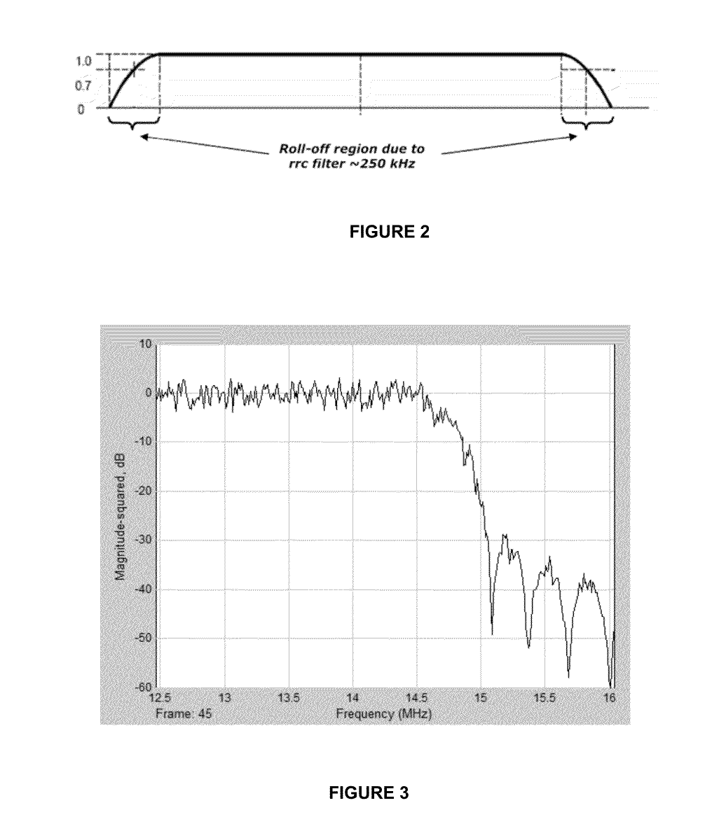

FIG. 2 illustrates the sidelobes that exist on a QAM channel. These sidelobes are due to the root-raised cosine filtering. In an embodiment, the sidelobes are used to create a roll-off region of usable space between adjacent QAM channels. The usable space may be used without disturbing relevant data information in the QAM channel itself. This roll-off region provides approximately 250 KHZ in bandwidth or 500 KHZ in total between QAM channels. FIG. 3 is a diagram illustrating a MATLAB simulation along with the measured QAM channel roll off.

Although 250 kHz of bandwidth appears to be available, there is a chance that transmitted energy inside the QAM band may leak through the receiving end filter and cause errors during demodulation. In order to determine what level of signal leakage below the QAM starts to impact the demodulation, an additive white Gaussian noise channel of 250 kHz bandwidth is injected on the QAM band-edge. The 256-QAM signal itself was transmitting random data, but did not have any forward error correction or interleaving. This provided a worst-case scenario. Testing of the MATLAB model yielded the following table which can be used to determine how far down the spread spectrum signal must be placed in order to not generate any errors.

| dB Down from QAM | Measured Bit Error Rate (BER) |
|---|---|
| 20 | <5 × 10⁻⁴ |
| 15 | <5 × 10⁻⁴ |
| 10 | 2.04 × 10⁻² |
| 5 | 0.12 |

Based on this data it is recommended that a spread spectrum signal of 500 kHz (250 kHz+250 kHz between adjacent QAM channels) be placed between 20 dB and 40 dB down from the QAM channel.

Generally, the structure of a Direct-sequence spread spectrum (DSSS) is one in which the information signal is being modulated by a pseudo-noise (PN) code. The name ‘spread spectrum’ comes from the fact that the carrier signals occur over the full bandwidth (spectrum) of a device's transmitting frequency.

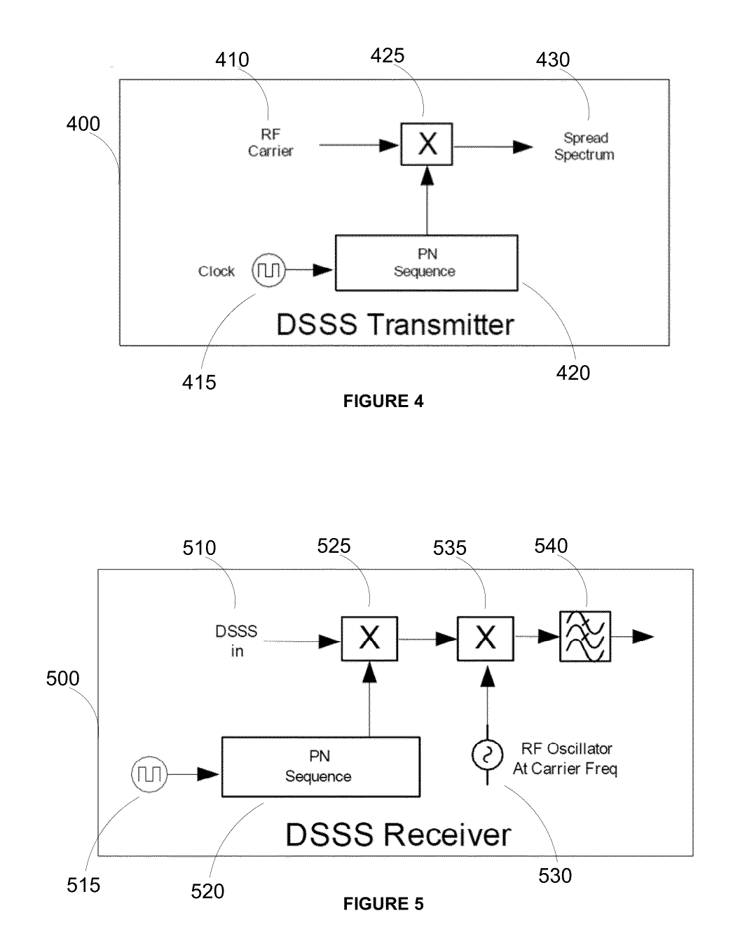

FIG. 4 illustrates a high-level block diagram of a DSSS transmitter 400, in accordance with an embodiment. On the other hand, the high level architecture of the DSSS receiver is effectively the reverse of the transmitter with the addition of a carrier down-conversion and a low-pass filter. The latter is only necessary if information is modulated on the carrier.

In the DSSS transmitter 400, a radiofrequency carrier 410 is modulated by a modulator 425 using a PN sequence 420. The PN sequence 420 is based on a clock 415 within the DSSS transmitter 425. Therefore, a DSSS signal 430 may be transmitted by the DSSS transmitter 400.

FIG. 5 illustrates a high-level block diagram of a DSSS receiver 500, in accordance with an embodiment. The DSSS receiver 500 receives an incoming DSSS signal 510 leaking from a leak in the network. It is demodulated using a first demodulator 525, using a PN sequence 520 based on a clock 515, and a second demodulator 535, which uses an RF oscillator 530 at the carrier frequency. A wave 540, ready to be interpreted because it is demodulated, is then outputted by the DSSS receiver 500.

Furthermore, in prior art technologies, such as in the QAM Snare approach, QAM signals are detected in a receiver that has to be synchronized with the signal that is measured by a recorder at the head of the network. Qualifying the signal requires a comparison between the data recorded by these two subsystems (recorder at the head, and receiver). This comparison needs either post-treatment of the data (which introduces delay), either a wireless communication (which requires a wireless communication network). According to an embodiment of the present system and method therefor, there is no need for such comparison, because the signature is found in the signal itself. This signature can be, for example, a pseudo-noise (PN) sequence.

### Spread-Spectrum in Noise

An important aspect of any spread-spectrum system is its ability to operate in the presence of other signals or even in negative SNR conditions. This comes from a function of de-spreading the signal on the receiver end using signal processing and retrieving the original modulated signal. The gain that occurs during de-spreading is called “Processing Gain”. Taking a high-level assessment of DSSS, one can calculate the processing gain achievable in the available bandwidth between two QAM channels using the following equation:

$${[ Processing Gain ]}_{d B} = 10 {log}_{10} ( \frac{{W}_{ss}}{{R}_{b}} ) , \\ where$$

$${W}_{ss} = the bandwidth , \\ {R}_{b} = data rate in bits per second$$

In order to determine maximal performance, a data rate of one (1) bit per second may be used. With the known bandwidth of, the processing gain can be calculated:

$${[ Processing Gain ]}_{d B} = 10 {log}_{10} ( \frac{500 kHz}{1 bps} ) = 57 dB$$

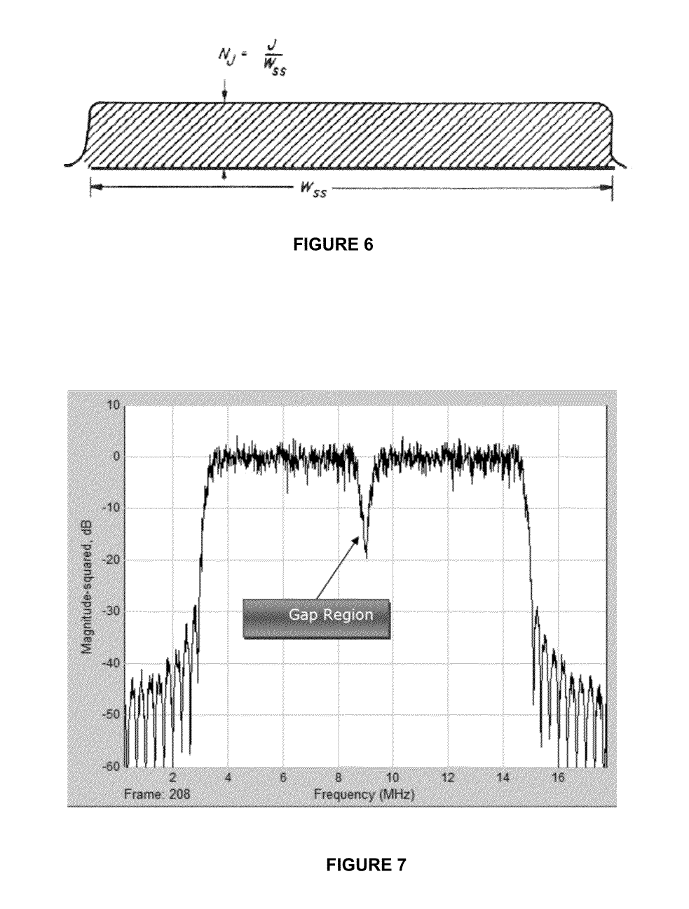

In an embodiment, adjacent QAM channels are treated as a “constant power broadband noise jammer”. The assumptions of this type of impairment are that there is a constant power across the region of transmission and that the signal has no knowledge of the coding sequence in the spread-spectrum signal. FIG. 6 illustrates an exemplary visualization of the jammer.

The actual impairment generated by adjacent QAM channels should be less than a constant power broadband noise jammer. This is because there is a gap region between the QAM channels, providing for improved signal-to-jammer ratio (S/J) in transmission range. The notch can be visualized in the exemplary MATLAB FFT of two adjacent Annex B J.83-based 256-QAM channels, shown in FIG. 7.

To accurately measure the strength of a CW signal, the embodiments conservatively assume an SNR>10 dB (though levels of 3 dB SNR should be sufficient). This would require a standard carrier wave to be +10 dB relative to the QAM channels. In order to ensure that the spread spectrum signal is well below any level that would interfere with a receiving device such as a set-top box or cable modem, the spread-spectrum signal shall be placed approximately −25 dB below the QAM channels. This gives a SNR (S/J) of −20 dB. The required processing gain (PG) to overcome the −20 dB S/J and return a measureable signal to +10 dB SNR is 20+10=30 dB PG. It has been demonstrated that a PG of 58 dB is theoretically achievable, so sufficient headroom is available to overcome the QAM signal. Further, it is desirable to use less processing gain if possible as this will result in the use of lower cost hardware.

### Normalized Power of Spread-Spectrum Signal

In the present embodiment, it has been proposed to lower the power level of the spread-spectrum signal 30 dB less than current CW or equivalent video carriers. It must be determined if a receiver is capable of receiving and detecting this spread-spectrum signal.

First the spread-spectrum signal must be normalized to the same power spectral density (PSD) as that of a CW. In order to do this, one must integrate the power over the proposed 500 kHz bandwidth. The sum of the power in the 500 kHz bandwidth will serve as a correction factor to the near infinite bandwidth of the CW signal, which may be defined as 1 Hz. To do this, the following well-known equation is used assuming that noise measurements are based on the CW RMS power:

$$dB = 10 log ( \frac{X Hz}{1 Hz} )$$

$$dB Correction = 10 log ( \frac{500 kHz}{1 Hz} ) = 57 dB$$

A correction factor of +57 dB indicates that the total RF power under the 500 kHz spread-spectrum channel is actually greater than the power of the single CW signal that is +30 dB higher normally used for leakage detection. Therefore, given the typical minimum threshold of 20 μV/m or the current leakage system one can make certain assumptions for the spread spectrum system. The spread spectrum power spectral density of the same signal would be 20 μV/m+57 dB −20 dB=1.45 mV/m. This is before de-spreading. After de-spreading the resultant signal will be significantly higher due to processing gain. Acquiring the spread spectrum signal will require an optimized receiver design.

### Optimized Receiver Design

Although the power level of the spread-spectrum channel is higher than the original CW, it is buried in a QAM channel that is effectively noisy. The PN sequence will be effective in extracting the spread-spectrum signal from the noise, provided there is sufficient signal to jammer (S/J) ratio. In this case, the signal is the spread-spectrum signal and the jammer is the QAM signal.

The S/J ratio must be greater than the spread-spectrum signal is below the jammer, which has been proposed to be −20 dB. The S/J ratio must also be less than the processing gain, which has been proposed to be 57 dB. Therefore the S/J>20 dB shall be satisfactory at the output of the A/D. In order to achieve an S/J>20 on the output of the A/D, the input of the A/D must be filtered around the spread-spectrum signal in order to maximize dynamic range. This will require an IF stage and IF filter slightly larger than the spread-spectrum signal. A SAW filter may be used for optimal filtering.

A low-cost mixing circuit may be sufficient to down-convert the spread-spectrum signal to the IF. After the filter it would be desirable to have a low-noise amplifier (LNA) for optimal gain control into the A/D. Typically the LNA would be at maximum amplification to ensure the A/D is at full scale, but can be attenuated when the A/D is overdriven in the presence of high leakage conditions.

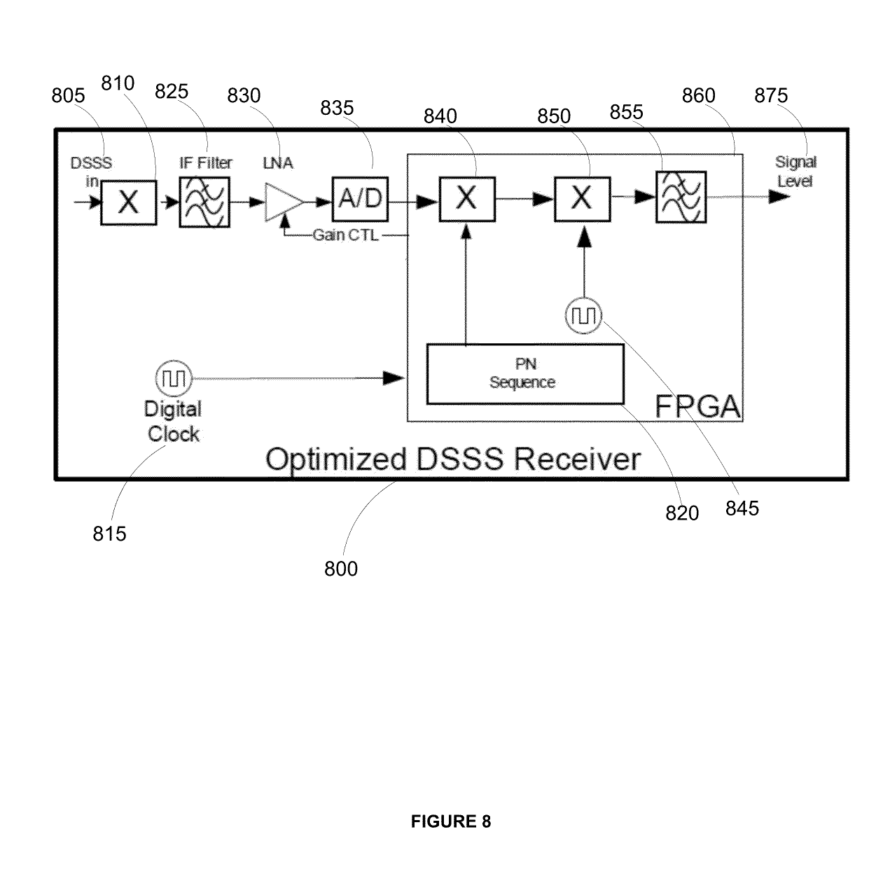

In the diagram of FIG. 8, it is assumed that a field-programmable gate array (FPGA) 860 is used for all processing such as tuning, gain control, clocking, etc. These functions can be implemented by other methods as chosen to best optimize cost. The output of “Signal Level” can likewise be modified to RSSI, data out, etc. as deemed appropriate to the design.

FIG. 8 illustrates an example of a high-level block diagram of an optimized DSSS receiver 800, in accordance with an embodiment. An incoming DSSS signal 805 is received by the optimized DSSS receiver 800 and demodulated by a first demodulator 810. According to another embodiment, the first demodulator 810 may comprise multiple demodulators in parallel. A first filter 825 is then used. The signal is amplified by amplifier 830 which is controlled by the FPGA 860. An A/D 835 is used, and the signal then enters the FPGA 860. A digital clock 815 is used by the FPGA 860, and by the PN sequence 820 within the FPGA 860 that is used by a second demodulator 840. A second clock 845 controls the third demodulator 850. A second filter 855 is comprised in the FPGA 860. An outputted signal 875 can be interpreted when it is outputted.

### Transmission of Data

Transmission of data over the DSSS channel may be done in a number of ways including:
FM modulation on the CW which is then spread by the PN code;
Modulation of the PN code through shifting the sequence; and
Spreading a BPSK or higher order modulation then up-converting with CW

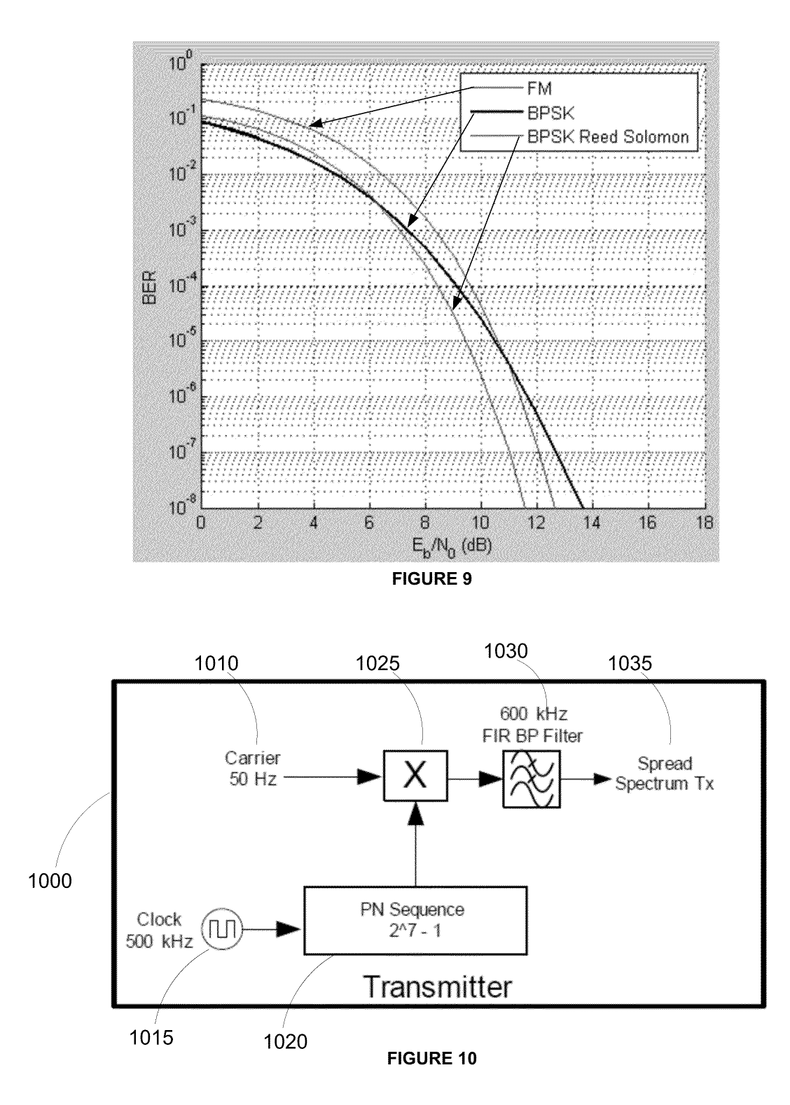

FIG. 9 is a diagram illustrating graphs representing the performance of each type of modulation. From a cost standpoint in FPGA coding and space, FM modulation may be the simplest route to take. Alternatively, in another embodiment, from a data robustness perspective, it may be more prudent to consider a modulation such as BPSK with a forward error protection (FEC). Even with a low level FEC such as Reed Solomon, the diagram illustrated in FIG. 10 indicates that BPSK with FEC performs better than FM modulation. Even BPSK without error correction performs better than FM in high noise conditions (the low noise performance is due to receiver skew from added multi-path impairment in this model).

FIG. 10 is a block diagram illustrating a high level architecture of another DSSS transmitter 1000, in accordance with another embodiment. In the embodiment of FIG. 10, the DSSS transmitter 1000 includes a simple FIR filter 1030 added to the design to remove images of the signal and sin c(x) out-of-band noise. A carrier 1010 at a frequency of 50 Hz, for example, may be generated and modulated by a modulator 1025, which is based on a PN sequence 1020 that uses a clock 1015 working at 500 kHz. A DSSS signal 1035 can thus be outputted by the DSSS transmitter 1000. It is also contemplated that a well designed matched filter may also be used in other designs. In the design of FIG. 10, the spread spectrum signal is externally up-converted to RF outside of the FPGA. This will allow for lower cost FPGAs and a lower overall cost of goods.

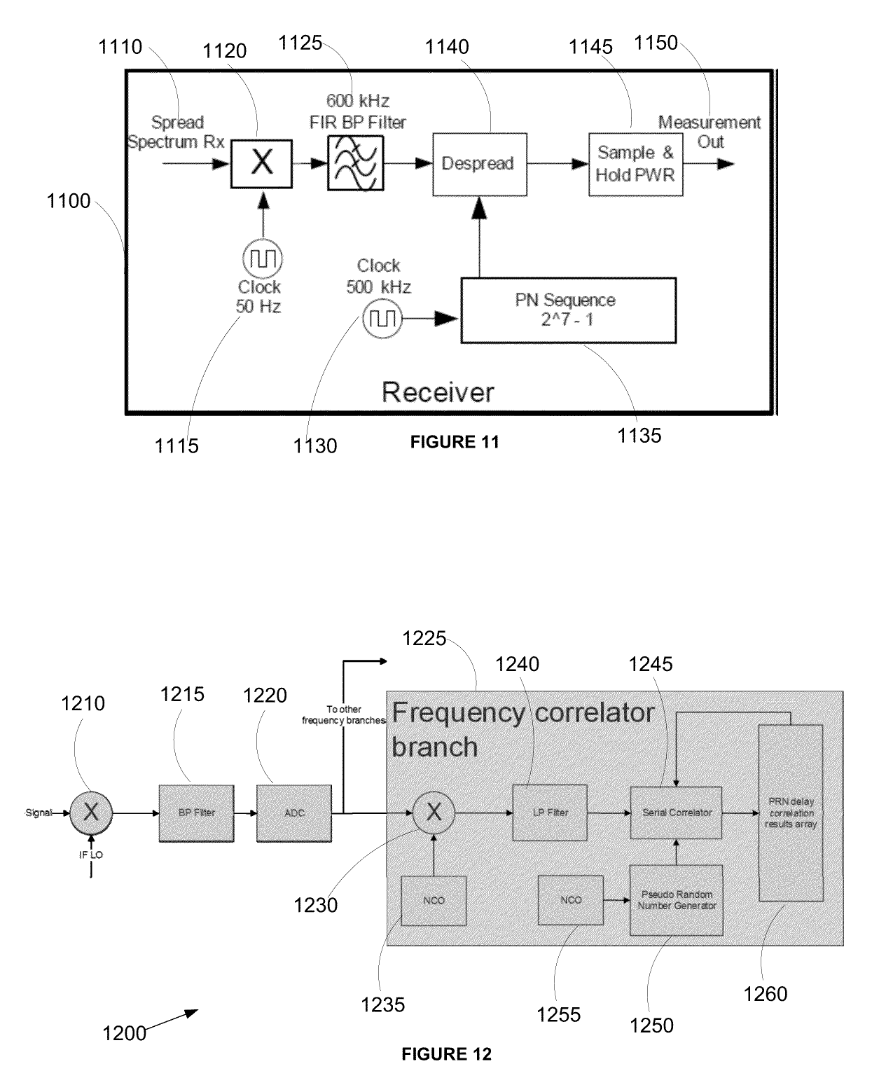

FIG. 11 is a block diagram illustrating a high level architecture of a DSSS receiver 1100 that is compatible with the transmitter of FIG. 10, in accordance with another embodiment. Similarly, a simple de-spreader 1140 may be modeled on the receiver using a multiplier 1120, based on a 50 Hz clock 1115, and a correlator using a PN sequence 1135 based on a 500 kHz clock 1130. A sample and hold circuit 1145 can be used before the output signal 1150 goes out from the receiver to be interpreted. The input filter shown may be replaced with a matched filter as previously discussed in order to reduce FPGA resources. A simple sample and hold power estimator may be included to average power measurements on the CW signal, which will be crucial when channel impairments are added for fading, AWGN, multipath, etc.

PRBS data may be transmitted through each QAM channel. In some cases, testing has proven the ability to transmit and recover a DSSS channel 20 dB below a QAM channel, and measure the signal in the DSSS while not causing any measureable impairment to the QAM channels.

FIG. 12 is a diagram illustrating another embodiment of a DSSS receiver 1200. The signal goes through a demodulator 1210, a low-pass filter 1215 and an ADC 1220. Then, there are multiple frequency correlator branches 1225 in which the pre-filtered signal enters. In each one, there is a demodulator 1230 coupled to a first NCO 1235. There is another low-pass filter 1240 and a serial correlator 1245. The serial correlator 1245 receives input from a pseudo-random number (PRN) generator 1250 coupled to a second NCO 1255. The serial correlator 1245 outputs its filtered and demodulated signal to a PRN delay correlation results array 1260. This receiver may be used even when it is not known if the PRN generator and the signal are synchronized. In this case, various delays have to be tested. It explains the loop from the PRN delay correlation results array 1260 to the serial correlator 1245 found in FIG. 12.

### PN Correlation

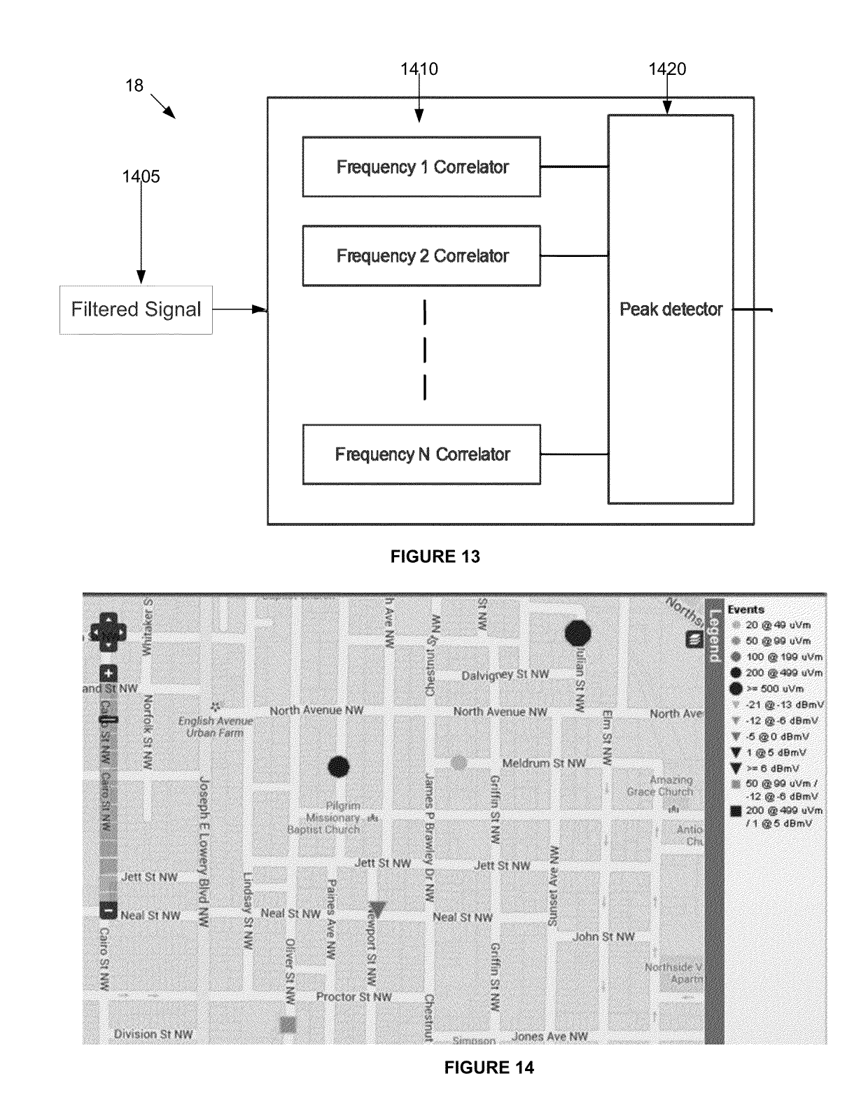

The DSSS receiver 18 comprises many branches, called frequency correlators 1410, that can correlate many different central frequencies in parallel. The frequency correlators 1410 are shown in FIG. 13. One of them is also shown in FIG. 12. In an embodiment, such an action is performed on a filtered signal 1405, which is the signal after it is received and filtered using a low-pass filter. These central frequencies are computed using the maximal power loss and the clock deviation of the transmitter 12 compared to that of the DSSS receiver 18. There is thus no need for a feedback loop, avoiding delays. This absence of post-correlation allows a fast response time for leakage detection, leading to real-time detection.

In order to correlate the PN sequence, the received signal has to be multiplied with all the time lags of the possible local PN sequences because the PRN (pseudorandom noise) encoded in the received signal may be out of phase with the local PRN of the receiver. A peak will then appear in the correlation function graph for the delay corresponding to the PN sequence encoded in the received signal. There is thus a need for a peak correlator 1420 in the DSSS receiver 18. According to an embodiment of the proposed architecture, a correlator can multiply the received signal with all possible time lags of the local PN sequence. All the results are saved in a memory in order to find the peak corresponding to the right time lag of the local PN sequence. According to another embodiment, time-lagged correlation may be used, but it is more costly.

Leakage intensity may be estimated using at least two methods. The first one consists of using the peak in the correlation function computed by a FPGA. This method may be employed when there is no QAM channel close to the DSSS signal. In another embodiment, leakage of a QAM channel may be measured directly in a 25 kHz band using a peak detector. The measurements will then be compared with a calibration table providing the intensity of the electric field.

### Leakage Data Collection and Analysis

Referring back to FIG. 1, the transmitter 12 at the head station 14 injects the DSSS signal between adjacent QAM channels. If there is a leak 16 in the network, the DSSS signal radiates through the leak 16. Once the DSSS receiver equipped vehicle 17 starts driving in the city/area where the network is deployed, the DSSS receiver 18 detects the DSSS signal and collect information about the DSSS signal detected, such as the signal strength. The information collected may then be associated with the location of the leak to generate a leakage event data package. The leakage event data package may be sent to an access point 20 for storage and processing in real time by an application server 22, or stored in a database on board of the vehicle 17 for future processing by an application server 22. The vehicle 17 may be equipped with a GPS (e.g., a geo-locating device) or other means to associate the DSSS signal leak with the location where the leak was detected.

The leakage event data package collected and/or stored may be processed by an application server 22 to eliminate multiple appearances of the same leak 16 that could have been previously detected or detected by any other vehicle which is part of the operator's fleet. This post-processing will avoid sending multiple technicians to the same recurring ingress/leak event location. Ingress/leak repairs can be dispatched by the application server 22. The application server 22 can manage the status of dispatched or repaired ingress/leak events. Ingress repairs could also be dispatched to a work force management system via a data interface.

FIG. 14 is an exemplary illustration of an Event Map showing ingress/leak events identified by color and form legend within a geographical area. The map indicates the event type and the location thereof. The map illustrated in FIG. 14 may be generated by the application server 22. As discussed above, the vehicle 17 is coupled to a GPS to send the geo-location of the vehicle 17 at the time the DSSS receiver 18 detects a DSSS signal that leaked from the network. Therefore, leakage event data package sent from the vehicle 17 to the access point 20 (or stored in the database on board of the vehicle 17) includes data associated with the DSSS signal detected (e.g., signal strength, etc.) and the location where the DSSS signal was detected. The location may be extracted from the leakage event data package to determine the approximate location of the leak. The events may be sorted in accordance with their type and signal strength as received at the DSSS receiver 18. Different shapes and colors may be used to indicate the type of event and signal strength as shown in the legend section of the map illustrated in FIG. 14.

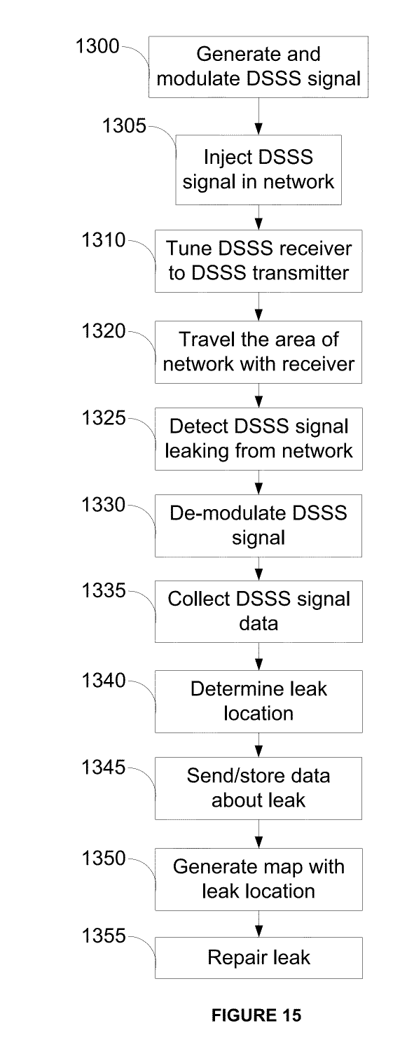

FIG. 15 is a flowchart that summarizes how the system described hereinabove can be used in a method for detecting a leak and determining its location. According to an embodiment, the steps of the method are as follows.

At step 1300, a DSSS signal is generated and modulated by a DSSS transmitter. This DSSS signal is injected in the cable distribution network at the head station at step 1305. Elsewhere, at step 1310, a DSSS receiver has to be tuned to the same frequency as the DSSS transmitter in order to detect the DSSS signal that has been transmitted. The DSSS receiver can be mounted on a vehicle or held by a person. The vehicle or person travels, at step 1320, in the area where the cable distribution network is deployed. If there is a leak in the network, the DSSS signal, emitted at the head station by the DSSS transmitter at step 1305, will leak outside the network through the leak. Step 1325 thus consists of detecting the leaking DSSS signal using the DSSS receiver. Since the signal was modulated at step 1300, it has to be demodulated by the DSSS receiver, which is step 1330. Data about the DSSS signal can be collected at step 1335. Steps 1330 and 1335 can be present or absent, depending on the embodiment. An embodiment in which they are absent would be simpler to implement. An embodiment in which demodulation is present would add a greater certitude to the detection. The data of step 1335 can include, for example, the strength of the signal (amplitude, intensity, etc.), or information stored in the modulated signal (emission time, location of the head station and other information that can be stored in a modulated signal). With the strength of the signal, especially when the strength is recorded at various locations, it is possible to determine the location of the leak (step 1340). A person walking or driving a vehicle can determine the location using a trial and error approach, or a processor may determine the location by comparing the strength of the leaking DSSS signal at various locations (for example, the location at which the leaking DSSS signal is the strongest is the closest one relative to the leak location). It the latter case, a map indicating the estimated position of the leak or leaks can be generated (step 1350). Multiple appearances of the same leak can be identified manually or automatically by a processor and deleted from the map. At step 1355 (which can happen just after the leak is detected or after some time has passed), the leak can be repaired by an individual or a team with the required qualifications.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for detecting a leak in an all-digital cable distribution network deployed in an area and comprising a head station for transmitting content to subscribers using channels that are encoded using quadrature amplitude modulation (QAM), the method comprising:
injecting at the head station, through the all-digital cable distribution network and using a direct sequence spread spectrum (DSSS) transmitter, a DSSS signal of a frequency range not overlapping with an adjacent QAM channel;
travelling the area where the all-digital cable distribution network is deployed, with a DSSS receiver tuned to the DSSS transmitter at the head station;
upon detecting, at the DSSS receiver, a DSSS signal leaking through the leak of the cable distribution network, collecting data indicative of a strength of the DSSS signal and associating the collected data with a location at which the DSSS signal was detected for generating leakage event data; and
at least one of transmitting and storing the leakage event data for processing.

2. The method of claim 1, wherein detecting the DSSS signal at the DSSS receiver comprises de-spreading the signal for retrieving an original modulated signal.

3. The method of claim 1, wherein generating a leakage event data comprises processing the leakage event data to eliminate multiple appearances of a leak.

4. The method of claim 3, wherein generating a leakage event data further comprises generating a map indicating the leak.

5. The method of claim 4, wherein generating a map indicating leak events comprises using specific symbols to indicate at least one of a type of event and a signal strength, the specific symbols comprising at least one of a specific shape and a specific color.

6. The method of claim 1, further comprising dispatching repairs to a work force management system via a data interface.

7. A method for detecting a leak in an all-digital cable distribution network deployed in an area and comprising a head station for transmitting content to subscribers using channels that are encoded using quadrature amplitude modulation (QAM), the method comprising:
injecting at the head station, through the all-digital cable distribution network and using a direct sequence spread spectrum (DSSS) transmitter, a DSSS signal of a frequency range not overlapping with an adjacent QAM channel;
travelling the area where the all-digital cable distribution network is deployed, with a DSSS receiver tuned to the DSSS transmitter at the head station;
upon detecting, at the DSSS receiver, a DSSS signal leaking through the leak of the all-digital cable distribution network, determining a location of a leak for repair.

8. The method of claim 7, wherein detecting the DSSS signal comprises collecting data indicative of a strength of the DSSS signal for determining the location of a leak.

9. The method of claim 7, wherein detecting the DSSS signal at the DSSS receiver comprises de-spreading the signal for retrieving an original modulated signal.

10. A system for detecting a leak in an all-digital cable distribution network deployed in an area, the system comprising:
a head station for transmitting content to subscribers using channels that are encoded using quadrature amplitude modulation (QAM);
a direct sequence spread spectrum (DSSS) transmitter for injecting at the head station, through the all-digital cable distribution network, a DSSS signal of a frequency range not overlapping with an adjacent QAM channel; and
a DSSS receiver tuned to the DSSS transmitter at the head station for detecting a DSSS signal leaking through the leak of the all-digital cable distribution network.

11. The system of claim 10, further comprising a processor configured for determining a location of a leak for repair.

12. The system of claim 10, wherein the DSSS receiver is installed on a vehicle for travelling the area where the all-digital cable distribution network is deployed.

13. The system of claim 12, wherein the vehicle comprises a geo-locating device installed thereon for determining the location at which the DSSS signal was detected.

14. The system of claim 10, wherein the DSSS receiver comprises a handheld portable receiver.

15. The system of claim 10, wherein the DSSS transmitter for injecting the DSSS signal comprises a DSSS transmitter for injecting the DSSS signal of a bandwidth comprised between 400 kHz and 600 kHz.

16. The system of claim 10, wherein the DSSS receiver comprises a FPGA configured for frequency tuning the DSSS receiver to the DSSS transmitter.
